(19) United States
(12) Patent Application Publication
(10) Pub. No.: US 2012/0134729 A1
(43) Pub. Date: May 31, 2012

(54) Tape Route Maintaining Mechanism, Tape Cartridge, Tape Printer And Tape Route Maintaining Method

(75) Inventor: Tomoyuki Kubota, Nagano-ken (JP)

(73) Assignee: SEIKO EPSON CORPORATION, Tokyo (JP)

(21) Appl. No.: 13/305,475

(22) Filed: Nov. 28, 2011

(30) Foreign Application Priority Data
Nov. 29, 2010 (JP) 2010-264719

(51) Int. Cl. B41J 33/10

(52) U.S. Cl. 400/194

(57) ABSTRACT

A tape route maintaining mechanism which maintains a predetermined position of a transfer route of a tape-shaped material with respect to a tape processing unit provided to perform a predetermined process for the tape-shaped material, along which route the tape-shaped material drawn from a tape body wound around a tape core, including: a bearing which is configured to extend along the normal of the tape body at a draw-out start point of the tape-shaped material to support the tape core such that the tape core can freely rotate and to allow shift of the tape body along the normal; and a draw-out start point maintaining unit which is configured to maintain a predetermined position of the draw-out start point when the tape body shifts along the normal of the tape body whose diameter decreases in accordance with the draw out of the tape-shaped material.

### CROSS-REFERENCE

The present application claims priority from Japanese Patent Application No. 2010-264719, filed on Nov. 29, 2010, which is hereby incorporated by reference in its entirety.

### BACKGROUND

It has become known to provide a tape printer with a roll sheet holder storage portion to which a roll sheet holder is attached, which roll sheet holder holds a roll sheet (tape-shaped material) as a unit around which the roll sheet is wound, a platen roller which draws the roll sheet from the roll sheet holder and transfers the roll sheet, and a thermal head which performs a printing process for the transferred roll sheet (see Japanese Patent Publication No. 2009-119861).

The roll sheet drawn from the roll sheet holder passes through a carrying unit disposed in front of the roll sheet holder storage portion in the horizontal direction, and undergoes the printing process executed by the platen roller and the thermal head disposed downstream. Then, the printed roll sheet is discharged through a sheet outlet port to the outside.

According to the related-art tape printer thus constructed, however, the draw-out start point of the roll sheet shifts toward the axis center thereof in accordance with decrease in the winding diameter when the number of windings of the roll sheet (tape-shaped material) wound around the roll sheet holder decreases after consumption of the roll sheet. In this case, the transfer route of the roll sheet from the draw-out start point to the carrying unit constantly varies. Thus, provision of the carrying unit (guide) capable of equalizing the angle at which the roll sheet is fed to the platen roller is required. Moreover, a sufficient space between the draw-out start point and the carrying unit is needed for allowing the variations of the transfer route. Accordingly, a certain space (distance) is required between the roll sheet holder storage portion and the platen roller, which imposes a limitation to the size reduction of the entire device and the degree of freedom for the layout of the internal mechanisms.

### SUMMARY

Various embodiments may provide a tape route maintaining mechanism, a tape cartridge, a tape printer and a tape route maintaining method capable of maintaining an appropriate position of a transfer route of a tape-shaped material drawn from a tape body, and reducing the distance between the tape body and a tape processing unit.

According to at least one embodiment of the disclosure, there is provided a tape route maintaining mechanism for maintaining a predetermined position of a transfer route of a tape-shaped material with respect to a tape processing unit provided to perform a predetermined process for the tape-shaped material, along which route the tape-shaped material drawn from a tape body being wound around a tape core. The tape route maintaining mechanism includes: a bearing which is configured to extend along the normal of the tape body at a draw-out start point of the tape-shaped material to support the tape core such that the tape core can freely rotate and to allow shift of the tape body along the normal; and a draw-out start point maintaining unit which is configured to maintain a predetermined position of the draw-out start point in case that the tape body shifts along the normal of the tape body whose diameter decreases in accordance with the draw out of the tape-shaped material.

According to at least one embodiment of the disclosure, there is provided a tape route maintaining method which maintains a predetermined position of a transfer route of a tape-shaped material with respect to a tape processing unit provided to perform a predetermined process for the tape-shaped material, along which route the tape-shaped material drawn from a tape body being wound around a tape core, includes: supporting the tape core such that the tape core can freely rotate along the normal of the tape body at a draw-out start point of the tape-shaped material and allowing shift of the tape body along the normal; and maintaining a predetermined position of the draw-out start point in case that the tape body shifts along the normal of the tape body whose diameter decreases in accordance with the draw out of the tape-shaped material.

According to this structure, the tape body shifts along the normal thereof while guided by the bearing in accordance with decrease in the winding diameter of the tape body produced by draw-out of the tape-shaped material. In this case, the draw-out start point of the tape-shaped material can be kept at a fixed position even when the winding diameter decreases (diameter decrease). Thus, the transfer route of the tape-shaped material from the draw-out start point to the tape processing unit does not change but is maintained at the fixed position. Moreover, the necessity of providing a component for guiding the transfer route toward a fixed position in the range from the tape body to the tape processing unit can be eliminated. Thus, the transfer route can be shortened.

When the transfer route of the tape-shaped material is maintained at the fixed position as in this structure, the space from the draw-out start point to the tape processing unit does not become a dead space. In this case, size reduction and a sufficient degree of freedom for positioning the internal mechanisms can be easily achieved. Moreover, the structure which does not require a dedicated component for changing or regulating the transfer route can simplify the transfer route, which contributes to prevention of problems such as a jam of the tape.

It is preferable that the tape route maintaining mechanism has the following structure. The tape core rotates around a horizontal axis, e.g. preferably the horizontal axis of the tape core. The tape-shaped material is drawn from the lower part of the tape body in the vertical direction. The draw-out start point maintaining unit has a tape receiving portion whose predetermined position receives the tape body shifting by the own weight of the tape body.

According to this structure, the tape body shifts downward by its own weight in accordance with the diameter decrease. In this case, the necessity of providing a dedicated mechanism (such as spring) for shifting the tape body is eliminated. Thus, simplification and size reduction of the mechanism can be achieved.

According to at least one embodiment of the disclosure, there is provided a tape cartridge including the tape route maintaining mechanism of the above aspect of the invention disposed within a cartridge case.

According to this structure, the tape-shaped material can be drawn out in a stable condition in the range from the draw-out start point of the tape-shaped material to the tape processing unit. Thus, a tape jam does not occur within the cartridge case.

According to at least one embodiment of the disclosure, there is provided a tape printer including: the tape cartridge of the above aspect of the invention; a ribbon cartridge including a ribbon core around which an ink ribbon is wound, and a winding core around which the ink ribbon drawn from the ribbon core is wound, the ribbon core and the winding core being accommodated within a ribbon case; a printing unit included in the tape processing unit to perform a printing process for the tape-shaped material while drawing the tape-shaped material from the tape body and feeding the tape-shaped material downstream; and a photoelectric detection unit disposed at a position between the tape cartridge and the printing unit and away from the ink ribbon exposed through the ribbon cartridge to detect the presence or absence of the tape-shaped material drawn from the tape body.

According to this structure, the transfer route of the tape-shaped material from the draw-out start point to the tape processing unit (printing unit) is maintained at a fixed position. In this case, the distance between the tape-shaped material located on the transfer route and the photoelectric detection unit is kept constant. Thus, the tape-shaped material can be securely detected in a stable condition by using the photoelectric detection unit.

Moreover, the photoelectric detection unit disposed at a position away from the drawn-out ink ribbon does not erroneously recognize the ink ribbon as the tape-shaped material. Accordingly, the condition in which the tape-shaped material wound around the tape core is completely drawn out (the tape-shaped material is finished) can be securely recognized, and determined as the occasion for performing appropriate processes such as printing stop and notification of the necessity for replacement of the tape body.

It is preferable that the tape printer further includes a contact member with which the tape-shaped material is brought into sliding contact is provided near a detector of the photoelectric detection unit so as to allow the detection and keep a constant distance between the detector and the tape-shaped material.

According to this structure, the tape-shaped material and the contact member can slidingly contact each other, the tape-shaped material sliding on the contact member. In this case, the distance between the tape-shaped material and the photoelectric detection unit does not change regardless of the position of the transfer route. Thus, the clearance between the tape-shaped material and the photoelectric detection unit can be kept constant even when the tape-shaped material slightly shifts on the transfer route during transfer, in which condition secure and stable detection of the tape-shaped material can be achieved.

### BRIEF DESCRIPTION OF THE DRAWINGS

Non-limiting and non-exhaustive embodiments of the present disclosure will be described with reference to the accompanying drawings, wherein like reference numbers reference like elements.

FIG. 1 is an exemplary schematic perspective view illustrating the external appearance of a tape printer.

FIG. 2 is an exemplary schematic perspective view illustrating the external appearance of the tape printer to which a tape cartridge and a ribbon cartridge are attached in the condition where a cover of the tape printer is opened.

FIG. 3 is an exemplary schematic perspective view illustrating the external appearance of the tape printer from which the tape cartridge and the ribbon cartridge are removed in the condition where the cover of the tape printer is opened.

FIG. 4A is an exemplary schematic cross-sectional view of the tape printer.

FIG. 4B is an exemplary schematic cross-sectional view of a first contact member according to a modified example.

FIG. 5A is an exemplary schematic front view of the tape cartridge.

FIG. 5B is an exemplary schematic side view of the tape cartridge.

### DESCRIPTION OF EXEMPLARY EMBODIMENT

A tape printer according to an embodiment of the invention is hereinafter described with the aid of the accompanying drawings. The tape printer discussed herein as a device to which a tape cartridge containing a printing tape wound in the shape of a roll and a ribbon cartridge containing an ink ribbon are attached draws out the printing tape and the ink ribbon, carries out printing on the printing tape transferred along with the ink ribbon, and cuts the printed portion of the printing tape to produce a label.

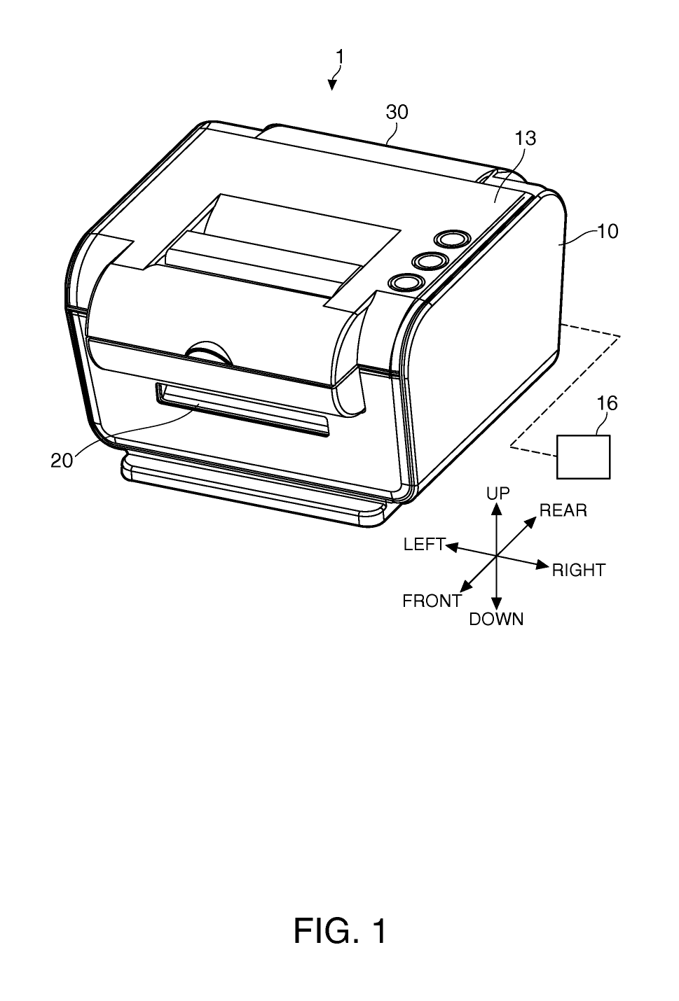

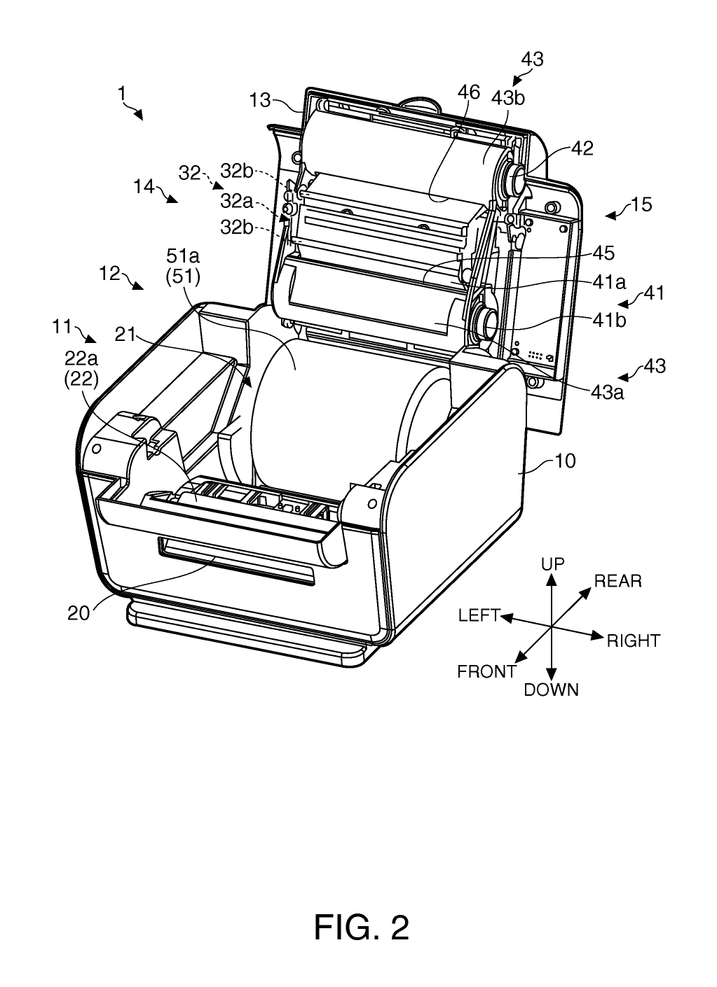

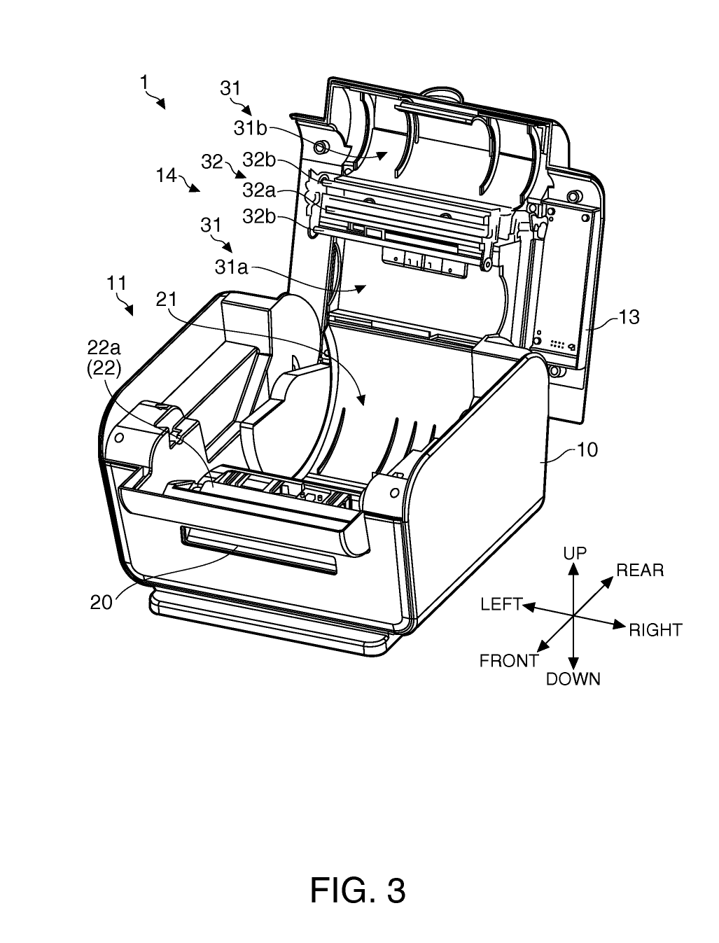

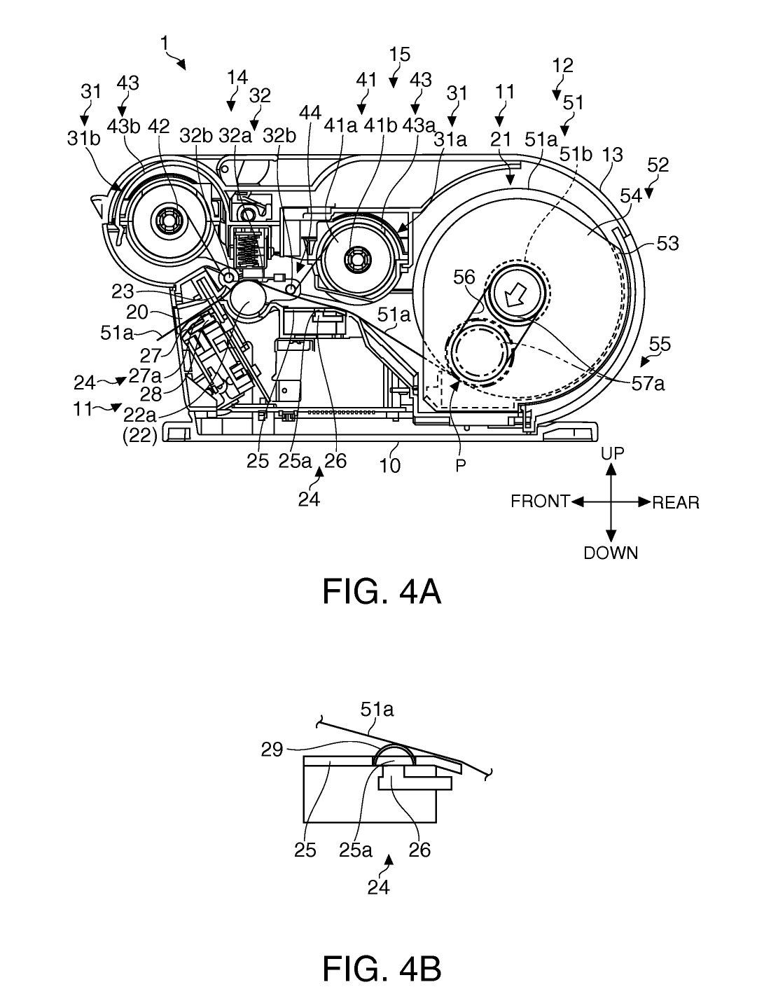

A tape printer 1 is now explained with reference to FIGS. 1 through 4B. FIG. 1 is a perspective view illustrating the external appearance of the tape printer 1. FIG. 2 is a perspective view illustrating the external appearance of the tape printer 1 to which a tape cartridge 12 and a ribbon cartridge 15 are attached in the condition where a cover case 13 is opened. FIG. 3 is a perspective view illustrating the external appearance of the tape printer 1 from which the tape cartridge 12 and the ribbon cartridge 15 are removed in the condition where the cover case 13 is opened. FIG. 4A is a cross-sectional view of the tape printer 1. FIG. 4B is a cross-sectional view of a first contact member 25 on which the tape can slide when being drawn according to a modified example. In the following description, the up-down direction, the front-rear direction, and the left-right direction are determined in conformity with the corresponding directions shown in the respective figures.

As apparent from FIGS. 1 through 3, the tape printer 1 includes a main body case 10 constituting the chief external case of the tape printer 1, a transfer assembly 11 incorporated within the main body case 10, the tape cartridge 12 attached to the interior of the transfer assembly 11 in such a manner as to be freely detachable therefrom, the cover case 13 provided to cover the upper part of the main body case 10 in such a manner as to be freely openable and closable, a printing assembly 14 incorporated within the cover case 13, and the ribbon cartridge 15 attached to the interior of the printing assembly 14 in such a manner as to be freely detachable therefrom. The tape printer 1 is connected with a controller 16 (such as personal computer) so that a user can manipulate the tape printer 1 by operation of the controller 16 for execution of printing operation.

The main body case 10 has a sheet outlet port 20 at the front center thereof as an opening through which a printing tape 51a after printing is discharged to the outside.

The transfer assembly 11 has a tape attachment portion 21 to which the tape cartridge 12 is attached, a tape transfer mechanism 22 which transfers the printing tape 51a while drawing the printing tape 51a from the tape cartridge 12, a cutter mechanism 23 which cuts the printed portion of the printing tape 51a, and a tape detection mechanism 24 which detects the presence or absence of the printing tape 51a drawn onto the transfer route.

The tape attachment portion 21 is a recess disposed inside the rear portion of the main body case 10 so as to position the tape cartridge 12 at the center (center in the left-right direction).

The tape transfer mechanism 22 which has a so-called platen roller 22a and a transfer drive device (not shown) for rotating the platen roller 22a is disposed in front of the tape attachment portion 21. The platen roller 22a contacts the lower surface of the printing tape 51a drawn from the tape cartridge 12, and transfers the printing tape 51a toward the sheet outlet port 20 disposed in front of the platen roller 22a and communicating therewith (see FIG. 4A).

As illustrated in FIG. 4A, the cutter mechanism 23 is a so-called pinch-type cutter device which faces to the printing tape 51a from above and below in the opposed direction such that the printing tape 51a can be sandwiched between the cutters of the cutter mechanism 23, and is disposed in front of the platen roller 22a (on the downstream side along the transfer route of the printing tape 51a). The portion of the printing tape 51a having received the printing process is cut by the cutter mechanism 23 and discharged through the sheet outlet port 20 to the outside.

The tape detection mechanism 24 is a so-called reflection type photo-sensor, and includes a first photo-electric element 26 incorporated in a first contact member 25 provided between the tape cartridge 12 and the tape transfer mechanism 22, and a second photoelectric element 28 incorporated in a second contact member 27 disposed to the sheet outlet port 20 in front of the cutter mechanism 23, exemplarily between the platen roller 22a and the sheet outlet port 20. A “photoelectric detection unit” in the appended claims may correspond to the first photoelectric element 26 and/or the second photoelectric element 28.

Each of the first contact member 25 and the second contact member 27 may constitute at least part of the transfer route of the printing tape 51a, and may have a table shape and a width substantially equivalent to the maximum width of the printing tape 51a. The tape 51a can slide on the contact members 25 and 27 when being drawn. The first contact member 25 has a first opening 25a substantially at the center thereof in the left-right direction as an opening constituting the optical path of the first photoelectric element 26. Similarly, the second contact member 27 has a second opening 27a constituting the optical path of the second photoelectric element 28. A detector (light emitting portion and light receiving portion) of the first photoelectric element 26 is disposed within the first opening 25a in such a position not to project from the upper end surface of the first contact member 25. Similarly, a detector (light emitting portion and light receiving portion) of the second photoelectric element 28 is disposed within the second opening 27a in such a position not to project from the upper end surface of the second slidingly contact member 27. The printing tape 51a drawn out and transferred is brought into slidingly contact with the surfaces of the first contact member 25 and the second contact member 27.

The tape detection mechanism 24, therefore, can detect the printing tape 51a positioned on the respective slidingly contact members 25 and 27. In addition, a tape route maintaining mechanism 55 (described later) of the tape cartridge 12 can maintain a constant distance between the respective photoelectric elements 26 and 28 and the printing tape 51a. In this structure, the distance between the printing tape 51a and the respective photoelectric elements 26 and 28 is kept constant even when the printing tape 51a slightly shifts on the transfer route during transfer. Accordingly, secure and stable detection of the printing tape 51a can be achieved.

For maintaining a constant clearance between the printing tape 51a and the tape detection mechanism 24 (photoelectric elements 26 and 28), a substantially hemispherical cover 29 may be attached to the first opening 25a of the first contact member 25 as illustrated in FIG. 4B, for example. In this case, it is preferable that the cover 29 is made of transparent material so as not to prevent detection of the printing tape 51a by using the tape detection mechanism 24. Similarly, the cover 29 of a similar type may be attached to the second contact member 27.

As illustrated in FIG. 2, the tape cartridge 12 has a tape body 51 which has the printing tape 51a wound around a tape core 51b, and a cartridge case 52 which supports the tape core 51b such that the tape core 51b can freely rotate. The tape cartridge 12 accommodates the printing tape 51a in such a manner that the printing tape 51a can be replaced with the new printing tape 51a of different types such as those having different widths or colors.

As illustrated in FIGS. 2 and 4A, the cover case 13 is a case whose front portion is raised and rotated around a hinge 30 (see FIG. 1) provided at the rear end of the cover case 13 to be used as an opening and closing cover through which the transfer assembly 11 (tape attachment portion 21) is exposed to the outside. Similarly, the printing assembly 14 (ribbon attachment portion 31) is exposed to the outside when the cover case 13 is opened. According to this structure, replacement of the tape cartridge 12 and the ribbon cartridge 15 and maintenance of the respective mechanisms can be conducted in the opened condition of the cover case 13.

The printing assembly 14 includes the ribbon attachment portion 31 to which the ribbon cartridge 15 is attached, and a printing mechanism 32 which performs a printing process for the printing tape 51a.

The ribbon attachment portion 31 has a draw-out attachment portion 31a recessed on the rear side of the printing mechanism 32, and a winding attachment portion 31b recessed on the front side of the printing mechanism 32. Thus, the ribbon cartridge 15 is attached to the ribbon attachment portion 31 in such a position as to cross over the printing mechanism 32.

The printing mechanism 32 has a so-called thermal head 32a, a head drive device (not-shown) which drives and controls the thermal head 32a, and a pair of ribbon route changing shafts 32b disposed before and behind the thermal head 32a so as to change a running path 44 of the ink ribbon 41a into such a position that an ink ribbon 41a faces to the heat releasing portion of the thermal head 32a.

As illustrated in FIGS. 2 and 4A, the ribbon cartridge 15 has a ribbon body 41 which has the ink ribbon 41a wound around a ribbon core 41b, a winding core 42 around which the used ink ribbon 41a is wound, and a ribbon case 43 which supports the ribbon core 41b and the winding core 42 such that these cores 41b and 42 can freely rotate.

The ribbon case 43 has a draw-out case 43a which accommodates the ribbon core 41b such that the ribbon core 41b can freely rotate, and a winding case 43b which accommodates the winding core 42 such that the winding core 42 can freely rotate. The draw-out case 43a and the winding case 43b are connected with each other in the front-rear direction with the running path 44 of the ink ribbon 41a located therebetween. The ink ribbon 41a drawn from the ribbon body 41 and exposed through a ribbon outlet port 45 formed on the draw-out case 43a passes along the running path 44, and enters a ribbon inlet port 46 formed on the winding case 43b to be wound around the winding core 42. The ribbon case 43 is a colored part having a dark color such as black.

For attachment of the ribbon cartridge 15 to the ribbon attachment portion 31, the draw-out case 43a is attached to the draw-out attachment portion 31a, while the winding case 43b is attached to the winding attachment portion 31b. By this attachment, the ink ribbon 41a drawn onto the running path 44 is brought into contact with the thermal head 32a and the pair of the ribbon route changing shafts 32b.

The thermal head 32a is disposed in such a position as to slidingly contact the printing tape 51a from above with the ink ribbon 41a interposed therebetween, while the platen roller 22a is disposed in such a position as to slidingly contact the printing tape 51a from below (see FIG. 4A). The printing tape 51a is sandwiched between the thermal head 32a and the platen roller 22a with the ink ribbon 41a provided therebetween as well. The printing tape 51a under this condition receives the printing process performed by the thermal head 32a while being drawn from the tape body 51 in accordance with the rotation of the platen roller 22a. The printing tape 51a after the printing process is fed toward the sheet outlet port 20, while the ink ribbon 41a is wound around the winding core 42. Each of the thermal head 32a and the platen roller 22a has a width substantially equivalent to the maximum width of the printing tape 51a. The winding core 42 and the platen roller 22a rotate in synchronization with each other.

The positional relationship between the first photoelectric element 26 of the tape detection mechanism 24 and the draw-out case 43a of the ribbon cartridge 15 is now explained.

The first photoelectric element 26 (the detector thereof) in this embodiment is disposed at a position opposed to the dark-colored draw-out case 43a. According to this structure, the first photoelectric element 26 disposed at a position away from the ink ribbon 41a exposed through the ribbon cartridge 15 and the pair of the ribbon route changing shafts 32b faces to the lower surface of the printing tape 51a to detect the printing tape 51a on the transfer route. Thus, the first photoelectric element 26 does not erroneously recognize the ink ribbon 41a as the printing tape 51a even when the ink ribbon 41a has a color similar to the color of the printing tape 51a. Accordingly, the condition in which the printing tape 51a wound around the tape core 51b is completely drawn out (so-called tape end detection) can be securely recognized, and determined as the occasion for performing appropriate processes such as printing stop and notification of the necessity for replacement of the tape cartridge 12. Moreover, accurate alignment can be made when the printing tape 51a is constituted by die-cut tapes. Similarly to the first photoelectric element 26, the second photoelectric element 28 is disposed to be opposed to the winding case 43b to detect discharge of the printing tape 51a.

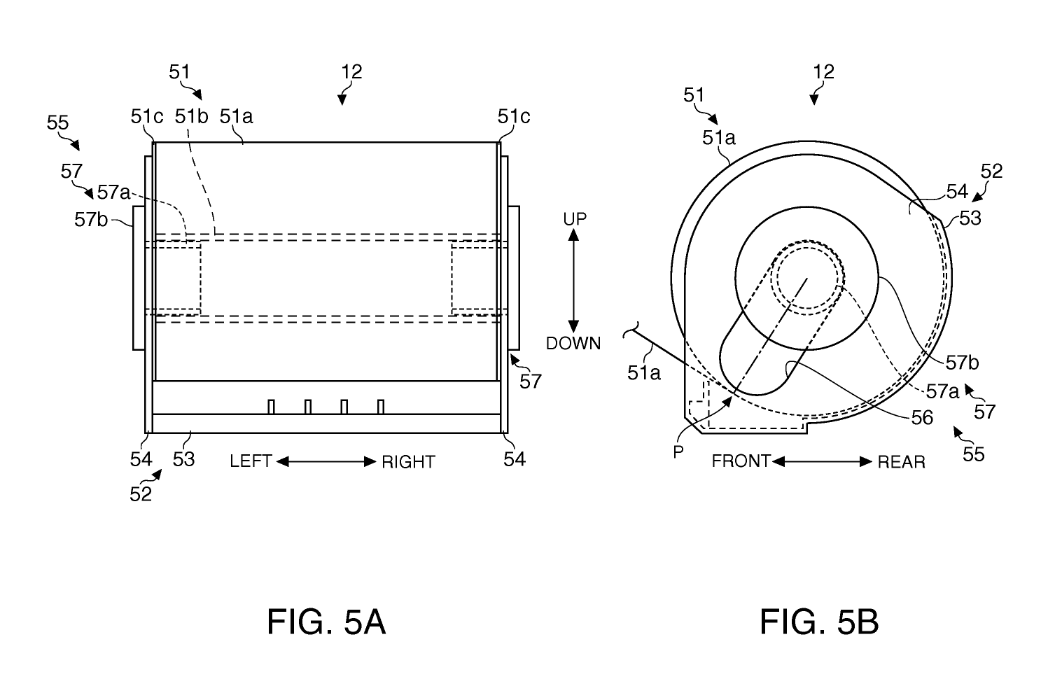

The details of the tape cartridge 12 are now explained with reference to FIGS. 4A and 4B and FIGS. 5A and 5B. FIG. 5A is a front view of the tape cartridge 12, while FIG. 5B is a side view of the tape cartridge 12. As explained above, the tape cartridge 12 has the tape body 51 and the cartridge case 52.

The tape body 51 has the printing tape 51a wound around the outer circumference of the hollow cylindrical tape core 51b. An adhesive sheet 51c is affixed to each end surface of the tape body 51 so as to prevent looseness of the wound printing tape 51a. An axial support member 57 provided at each end of the tape core 51b in the axial direction engages therewith so as to support the tape body 51 on both side walls 54 (described later) of the cartridge case 52 in such a manner that the tape body 51 can freely rotate.

The cartridge case 52 includes a tape receiving portion 53 which receives the circumferential surface of the tape body 51, a pair of the side walls 54 which stand on both ends of the tape receiving portion 53 in the left-right direction, and the tape route maintaining mechanism 55 which supports the tape body 51 by the axial support member 57 engaged with the side walls 54 and maintains a fixed position at which the printing tape 51a is drawn from the tape body 51.

The tape receiving portion 53 has a rear portion curved along the circumferential surface of the tape body 51 to support the sliding movement of the tape body 51 rotating in accordance with the draw out of the printing tape 51a. It is preferable that the tape receiving portion 53 is made of synthetic resin so as to allow smooth sliding of the tape body 51.

The tape route maintaining mechanism 55 has bearings 56 provided on each of the side walls 54, and a pair of the supporting members 57 which engage with the axial center of the tape core 51b via the corresponding bearings 56. The tape route maintaining mechanism 55 maintains a predetermined position of the transfer route for the printing tape 51a extending from a point at which the printing tape 51a is released and drawn from the tape body 51 (hereinafter referred to as “draw-out start point P”) to the position where the tape transfer mechanism 22 and the printing mechanism 32 are located.

Each of the bearings 56 is a corner-rounded rectangular opening extending diagonally downward toward the front from substantially the center of the corresponding side wall 54. More specifically, assuming that the direction of the drawn out printing tape 51a corresponds to the tangential line at the draw-out start point P, each of the bearings 56 extends in the direction passing the draw-out start point P and extending perpendicularly to the tangential line at the draw-out start point P, that is, extends along the normal. Each of the bearings 56 supports the tape core 51b such that the tape core 51b can freely rotate, and allows shift of the tape body 51 (tape core 51b) in the normal direction.

Each of the axial support members 57 has an engaging portion 57a inserted through the corresponding bearing 56 and engaging with the axial center of the tape core 51b, and a flange-shaped dial 57b connected with the engaging portion 57a. When the respective engaging portions 57a are brought into engagement with both ends of the tape core 51b in the left-right (axial) direction via the bearings 56, the respective axial support members 57 and the tape core 51b are tightly fixed to each other. In this condition, the respective axial support members 57 and the tape core 51b are supported in such a manner as to freely rotate with respect to the respective bearings 56. The respective dials 57b are rotated by the user to remove looseness of the wound printing tape 51a.

According to the tape route maintaining mechanism 55 in this embodiment, the tape body 51 (tape core 51b) shifts in the normal direction by its own weight while guided by the bearings 56 in accordance with the consumption of the printing tape 51a and decrease in the winding diameter (diameter decrease) (see alternate long and two short dashes lines in FIG. 4A). In this case, the draw-out start point P of the printing tape 51a does not change (shift) even when the diameter of the tape body 51 decreases. Thus, the transfer route of the printing tape 51a from the draw-out start point P to the tape transfer mechanism 22 and the printing mechanism 32 fixedly provided can be maintained at the fixed position. Accordingly, the clearance between the first photoelectric element 26 and the printing tape 51a can be kept constant, which contributes to prevention of erroneous detection. According to this embodiment, the tape transfer mechanism 22 and the printing mechanism 32 are fixedly provided on the transfer route.

When the transfer route of the printing tape 51a is maintained at the fixed position, the space from the draw-out start point P to the tape transfer mechanism 22 and the printing mechanism 32 does not become a dead space. In this case, size reduction of the tape printer 1 and a sufficient degree of freedom for positioning the internal mechanisms of the tape printer 1 can be easily achieved. Particularly, the structure which allows the tape body 51 to shift downward by its own weight does not require a dedicated mechanism (such as spring) for shifting the tape body 51. Thus, simplification and size reduction of the mechanism can be realized.

Moreover, such a component which changes or regulates the transfer route is not needed. Thus, the transfer route becomes simple, which contributes to prevention of problems such a jam of the printing tape 51a. Particularly, a jam of the printing tape 51a within the cartridge case 52 can be effectively avoided. A “draw-out start point maintaining unit” in the appended claims corresponds to the tape receiving portion 53, the side walls 54, and the axial support members 57. The ribbon cartridge 15 may be eliminated when the printing tape 51a is constituted by thermal roll paper, for example.

What is claimed is:

1. A tape route maintaining mechanism which maintains a predetermined position of a transfer route of a tape-shaped material with respect to a tape processing unit provided to perform a predetermined process for the tape-shaped material, along which route the tape-shaped material drawn from a tape body being wound around a tape core, comprising:
a bearing which is configured to extend along the normal of the tape body at a draw-out start point of the tape-shaped material to support the tape core such that the tape core can freely rotate and to allow shift of the tape body along the normal; and
a draw-out start point maintaining unit which is configured to maintain a predetermined position of the draw-out start point in case that the tape body shifts along the normal of the tape body whose diameter decreases in accordance with the draw out of the tape-shaped material.

2. The tape route maintaining mechanism according to claim 1, wherein:
the tape core rotates around the horizontal axis of the tape core;
the tape-shaped material is drawn from the lower part of the tape body in the vertical direction; and
the draw-out start point maintaining unit has a tape receiving portion whose predetermined position receives the tape body shifting by the own weight of the tape body.

3. A tape cartridge comprising the tape route maintaining mechanism according to claim 1 disposed within a cartridge case.

4. A tape printer comprising:
the tape cartridge according to claim 3;
a ribbon cartridge including a ribbon core around which an ink ribbon is wound, and a winding core around which the ink ribbon drawn from the ribbon core is wound, the ribbon core and the winding core being accommodated within a ribbon case;
a printing unit included in the tape processing unit to perform a printing process for the tape-shaped material while drawing the tape-shaped material from the tape body and feeding the tape-shaped material downstream; and
a photoelectric detection unit disposed at a position between the tape cartridge and the printing unit and away from the ink ribbon exposed through the ribbon cartridge to detect the presence or absence of the tape-shaped material drawn from the tape body.

5. The tape printer according to claim 4, further comprising a contact member with which the tape-shaped material is brought into sliding contact is provided near a detector of the photoelectric detection unit so as to allow the detection and keep a constant distance between the detector and the tape-shaped material.

6. The tape printer according to claim 5, further comprising a substantially hemispherical cover which is attached to an opening of the contact member so as to keep a constant distance between the detector and the tape-shaped material.

7. A tape route maintaining method which maintains a predetermined position of a transfer route of a tape-shaped material with respect to a tape processing unit provided to perform a predetermined process for the tape-shaped material, along which route the tape-shaped material drawn from a tape body being wound around a tape core, comprising:
supporting the tape core such that the tape core can freely rotate along the normal of the tape body at a draw-out start point of the tape-shaped material and allowing shift of the tape body along the normal; and
maintaining a predetermined position of the draw-out start point in case that the tape body shifts along the normal of the tape body whose diameter decreases in accordance with the draw out of the tape-shaped material.
